(19) United States
(12) Patent Application Publication
(10) Pub. No.: US 2026/0311392 A1
(43) Pub. Date: Oct. 8, 2026

(54) EMBEDDING CONTENT ON GENERATED CONTENT FOR A GROUP AUDIENCE

(71) Applicant: Motorola Mobility LLC, Chicago, IL (US)

(72) Inventors: Amit Kumar Agrawal, Bangalore (IN); Krishnan Raghavan, Bangalore (IN); Nakul Patel, Bangalore (IN)

(73) Assignee: Motorola Mobility LLC, Chicago, IL (US)

(21) Appl. No.: 19/173,074

(22) Filed: Apr. 8, 2025

(51) Int. Cl. G06T 11/60; G06F 16/535

(52) U.S. Cl. CPC G06T 11/60; G06F 16/535

(57) ABSTRACT

In accordance with the described techniques, a group context is detected in which multiple users are predicted to be consuming content together, and one or more shared characteristics of the multiple users are determined based on user data. A content generation query is received, and a content element is retrieved from a content database such that the content element is associated with the one or more shared characteristics and the content generation query. A generative artificial intelligence (AI) model is prompted to generate content based on the content generation query by embedding the content element on the generated content, which is then output.

### BACKGROUND

Generative artificial intelligence (AI) refers to a class of machine learning models designed to create content, such as images, text, audio, or video, based on input data. These models learn patterns from large datasets and use them to generate novel outputs. Popular applications of generative AI include text-to-image models, which create realistic or artistic images from textual descriptions. In addition to creative fields, generative AI is used for tasks such as image restoration, data augmentation, and simulating real-world environments. The ability of generative AI to produce high-quality, personalized content has made it a valuable tool across industries like entertainment, design, and more.

### BRIEF DESCRIPTION OF THE DRAWINGS

Aspects of embedding content on generated content for a group audience are described with reference to the following Figures. The same numbers may be used throughout to reference similar features and components that are shown in the Figures. Further, identical numbers followed by different letters reference different instances of features and components described herein.

FIG. 1 illustrates an example environment in which embedding content on generated content for a group audience can be implemented;

FIG. 2 illustrates an example system for embedding content on generated content for a group audience;

FIG. 3 depicts an example of embedding content on generated content for a group audience;

FIG. 4 depicts an example of embedding content on generated content for a group audience;

FIG. 5 illustrates a flow chart depicting an example method of embedding content on generated content for a group audience in accordance with one or more implementations;

FIG. 6 illustrates a flow chart depicting an example method of embedding content on generated content for a group audience in accordance with one or more implementations;

FIG. 7 illustrates various components of an example device in which aspects of embedding content on generated content for a group audience can be implemented in accordance with one or more implementations.

### DETAILED DESCRIPTION

Content generation using generative artificial intelligence (AI) models has become increasingly prevalent, allowing users to create personalized visual experiences based on text queries. However, conventional techniques for integrating pre-generated content elements into AI-generated content face significant challenges. One key issue is that the integrated content often lacks relevance to all users in a group context, leading to a disconnected viewing experience. Additionally, content elements are frequently placed in the background rather than seamlessly incorporated into the main subject of the generated content, resulting in a disjointed and unnatural appearance.

To address these limitations, a content embedding system is implemented by a device and leveraged for embedding content on primary objects of generated content for group audiences. As part of this, the content embedding system detects a group context in where multiple users are predicted to be consuming content together. For example, detecting the group context includes detecting content sharing to a group presentation device (e.g., casting content to a smart TV) in the presence of multiple users, or sharing media to a group chat including multiple users. By analyzing user data (e.g., interests, preferences, and demographics) of the multiple users participating in the group context, the content embedding system determines one or more shared characteristics of the multiple users.

As part of the content embedding process, the content embedding system receives a content generation query. The content generation query provides information, instructions, and/or context to the generative AI model for the purpose of generating content. The content embedding system is configured to analyze the content generation query, and extract a primary object from the content generation query. Generally, the primary object is a significant and/or central element of the content generation query that is to be generated as part of the generated content. In one example in which the content generation prompt is “generate an image of a stunning red car along an ocean drive,” the primary object is “car.” In addition, the content embedding system identifies candidate placements where content elements are embeddable on the primary object. The candidate placements can be the primary object as a whole and/or components of the primary object.

Furthermore, the content embedding system maintains a content database containing a plurality of content elements, e.g., logos or icons of brands, logos or icons of professional sports teams, etc. In one example, each content element is paired with one or more tags in the content database. Here, the content embedding system queries the content database with the candidate placements, and the content database returns the content elements paired with the candidate placements as tags in the content database. In the context of branded content elements (e.g., brand logos or icons), the content embedding system additionally retrieves brand information (e.g., promotions, brand voice, endorsements, campaign objectives, and sponsorships of the brand) paired with the brand in the content database.

The content embedding system is configured to output a selected content element from the retrieved content elements and a selected placement from the candidate placements on which to embed the selected content element. To do so, the content embedding system utilizes a machine learning model in one or more implementations. For example, the machine learning model is trained and/or prompted to select, from the retrieved content elements, a particular content element that is most relevant to the shared characteristics of the multiple users. Additionally or alternatively, the model selects the particular content element based on relevance to the content generation query, the brand information, and/or a shared environmental context of the multiple users. In addition, the machine learning model is trained and/or prompted to select, from the candidate placements, a particular placement exhibiting a highest degree of relevance to the selected content element.

In accordance with the described techniques, the content embedding system builds a prompt instructing the generative AI model to create generated content by embedding the selected content element on the selected placement of the primary object. In some examples, the request for generated content is a request to generate new content while the group context is detected. In other examples, the request for generated content is a request to adapt existing generated content to the group context. Here, the group context can be a user sharing previously generated content to a group chat. The previously generated content was generated in accordance with the described techniques by embedding a previous content element on the primary object of the previously generated content. However, the previous content element was selected based on a particular user's interests, preferences, and demographics, rather than the shared characteristics of the group. Given this, sharing of the previously generated content to the group chat causes the content embedding system to modify the previously generated content by replacing the previous content element with the content element selected based on the shared characteristics.

In the context of a request for new generated content element, the prompt includes the content generation query, the selected content element, and the selected placement. Here, the prompt instructs the generative AI model to create generated content by embedding the selected content element on the selected placement. In the context of a request to adapt existing generated content to the group audience, the prompt includes the previously generated content, the selected content element, and the selected placement. Here, the prompt instructs the generative AI model to create generated content by modifying the previously generated content to replace the previous content element with the selected content element. In addition, the prompt instructs the model to embed the selected content element at the selected placement, e.g., which can differ from the previous content element's original placement on the previously generated content.

In one or more implementations, the device implementing the content embedding system includes a local instance of the generative AI model stored thereon, and the local instance of the generative AI model creates the generated content. In variations, the device communicates the prompt to an additional device having increased memory and/or processing resources in comparison to the device. In these scenarios, the additional device creates the generated content, and communicates the generated content back to the device for output.

Thus, the described techniques extract primary objects from a content generation query, and retrieve content elements that are associated with and/or relevant to the primary object and/or components thereof. In addition, the described techniques select a particular content element for integration based on the shared characteristics of the group, e.g., the group's shared interests, preferences, demographics, and the like. Moreover, the described techniques embed the selected content element on the primary object, rather than some element of the background that is unrelated to the content generation query. Accordingly, the described techniques improve upon conventional techniques for pre-generated content integration by increasing the contextual relevance of the selected content element being integrated, and integrating the selected content element in a seamless and cohesive manner. This improves user satisfaction with the generated content, which reduces content regeneration attempts at the generative AI model. Indeed, due to increased satisfaction with the generated content, the user is less likely to prompt the generative AI model to create new and/or additional content, which conserves computational resources and improves computational efficiency at the computing device implementing the generative AI model.

In addition, the described techniques relate to offloading the content generation task to an additional device having increased processing and/or memory resources. For instance, the additional device is equipped with accelerator devices designed to speed up execution of machine learning workloads (e.g., neural processing units (NPUs), inference processors, and the like), while the device is not equipped with such accelerator devices. By offloading the content generation task to the additional device in the manner described, the described techniques enable and/or speed up the process of producing the generated content.

While features and concepts of embedding content on generated content for a group audience can be implemented in any number of environments and/or configurations, aspects of the described techniques are described in the context of the following example systems, devices, and methods. Further, the systems, devices, and methods described herein are interchangeable in various ways to provide for a wide variety of implementations and operational scenarios.

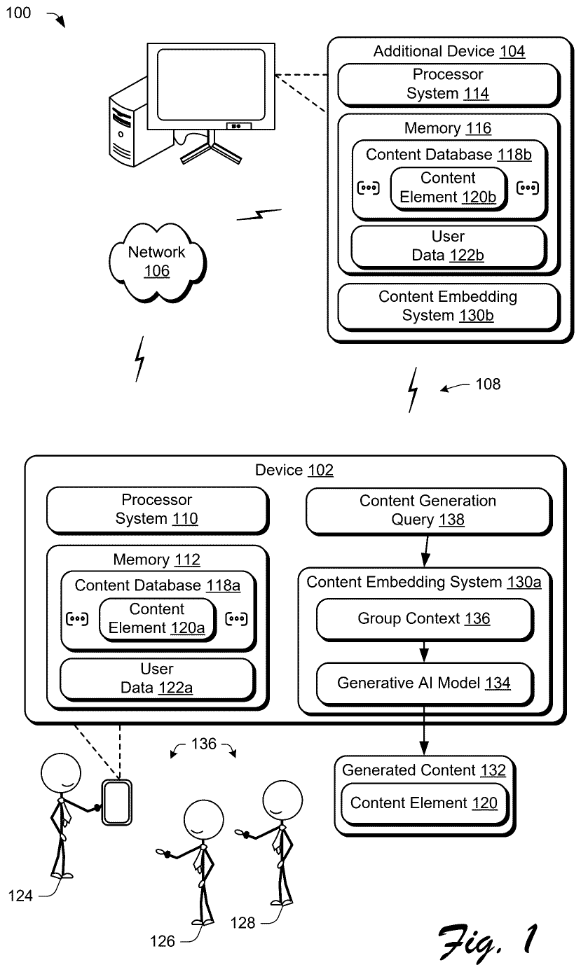

FIG. 1 illustrates an example environment 100 in which aspects of embedding content on generated content for a group audience can be implemented. The environment 100 includes a device 102 and an additional device 104 that are communicatively coupled over a network 106, such as a Wi-Fi network or a cellular network. Additionally or alternatively, the device 102 and the additional device 104 are communicatively coupled via a peer-to-peer connection 108 examples of which include a Bluetooth connection, a Bluetooth Low Energy (BLE) connection, a Wi-Fi Direct connection, a Near-Field Communication (NFC), an ultra-wideband (UWB), and/or a wired connection. Computing devices that implement the device 102 and the additional device 104 are configurable in a variety of ways. A computing device, for instance, is configurable as a desktop computer, a laptop computer, a mobile device (e.g., assuming a handheld configuration such as a tablet or mobile phone), one or more server devices, and so forth. Thus, a computing device ranges from full resource devices with substantial memory and processor resources (e.g., personal computers, game consoles, server devices) to a low-resource device with limited memory and/or processing resources (e.g., mobile devices). In at least one specific but non-limiting example, the device 102 is a mobile device (e.g., a smartphone) and the additional device 104 is a personal desktop computer, as shown.

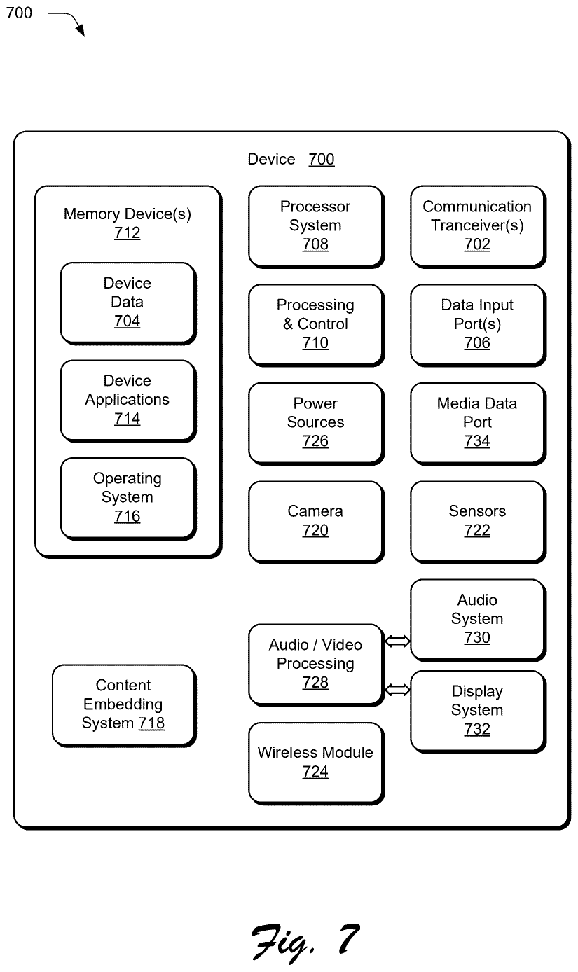

In one or more examples, the device 102 is implemented with various hardware components, such as a processor system 110 and a memory 112. Moreover, the additional device 104 is implemented with a processor system 114 and a memory 116. Broadly, the processor system 110, 114 is representative of one or more processors configured to process computer-executable instructions. Moreover, the memory 112, 116 is a system or device that enables storage of data. The memory 112, 116 can include non-volatile memory (e.g., read-only memory (ROM), flash memory, solid-state drives, etc.) and volatile memory, e.g., random access memory (RAM) dynamic random access memory (DRAM), static random access memory (SRAM), etc. Although not shown in FIG. 1, either device 102, 104 may include a display device, which is representative of functionality for output of graphical content via the device 102 and/or the additional device 104 e.g., in a user interface. The device 102 and the additional device 104 are also implemented with any number and any combination of different components, as further discussed below with reference to the example device 700 of FIG. 7.

As shown, the device 102 includes a content database 118a maintained in the memory 112, and the content database 118a includes a plurality of content elements 120a. Additionally or alternatively, the additional device 104 includes a content database 118b maintained in the memory 116, and the content database 118b includes a plurality of content elements 120b. Broadly, the content elements 120 are pre-generated image content elements and/or pre-generated video content elements to be integrated into generated content as generated by a generative artificial intelligence (AI) model. The content elements 120 are configurable in a variety of ways. In one or more implementations, the content elements 120 include branded content of a plurality of brands, such as brand logos, brand icons, products offered for sale by respective brands, brand advertisements, brand commercials, brand promotions, and the like. Additionally or alternatively, the content elements 120 include logos or icons of professional sports teams, representations (e.g., avatars) of people (e.g., athletes, musicians, celebrities) or characters (e.g., movie, television, and video game characters), university and school logos, seals, and crests, locale-related content (e.g., state or national flags, regional emblems, city seals and logos, cultural symbols and icons), and so on.

In addition, the device 102 includes user data 122a maintained in memory 112 and/or the additional device 104 includes user data 122b maintained in memory 116. Broadly, the user data 122 includes information associated with a user (e.g., the owner and/or registered user of the device 102), such as preferences, interests, and demographics of the user 124. Additionally or alternatively, the user data 122 includes information associated with other people (e.g., users 126, 128) that the user 124 frequently interacts with (e.g., friends or family members of the user 124), such as preferences, interests, and demographics of these users 126, 128. Examples of user preferences include content modality preferences (e.g., whether the users 124, 126, 128 prefer content to be output in image, video, and/or audio format) and visual content consumption preferences, e.g., whether the users 124, 126, 128 prefer to consume visual content that is bright or dark in color, simple or elegant in design, dense or spacious in layout, and so on. Examples of user interests include hobbies of the users 124, 126, 128 (e.g., gaming, fitness, and fashion), entertainment (e.g., movies, TV shows, books, and characters), sports (e.g., sports teams and players), and so on. Example user demographics include age, gender, income level, occupation, family status, ethnicity, etc. The user data 122 is collectable using any one or more of a variety of public or proprietary techniques and/or sources, examples include web tracking, interaction and engagement data tracking, search history and query collection, social media activity analysis, and so on.

Although illustrated as stored locally in the memory 112, 116 of the device 102 and the additional device 104, respectively, it is to be appreciated that the content elements 120 and/or the user data 122 are stored at a remote service provider system (not depicted). By way of example, the remote service provider system is implemented by one or more server devices and is configured to provide resources, data, and applications to the device 102 and/or the additional device 104, such as over a “cloud.” As part of this, the remote service provider system maintains the content database 118 including the plurality of content elements 120, as well as the user data 122 for the user 124 and/or a plurality of other users, e.g., users 126, 128. The remote service provider system, for instance, maintains a plurality of user profiles containing the user data of different users, and optionally, categorizes the plurality of users into segments using profiling and segmentation techniques. In this way, the device 102 and/or the additional device 104 can retrieve data (e.g., content element(s) 120 and user data 122) upon request to the remote service provider system. By way of example, the device 102 and/or the additional device 104 communicates a request for data over the network 106 to the remote service provider system, and in response, the remote service provider system returns the requested content elements 120 and/or user data 122 of various requested users, e.g., users 124, 126, 128.

In accordance with the described techniques, the device 102 includes a content embedding system 130a and/or the additional device 104 includes a content embedding system 130b. Broadly, the content embedding system 130 is representative of functionality for embedding a content element 120 on generated content 132 as generated by a generative AI model 134. In particular, the content embedding system 130 is configured to detect a group context 136, which is a scenario or situation in which multiple users 124, 126, 128 are predicted to be consuming content together. Given this, the content embedding system 130 embeds a content element 120 onto the generated content 132 that corresponds to one or more shared characteristics of the multiple users 124, 126, 128.

As shown in the illustrated example, the group context 136 may be detected as multiple users co-located at a same physical location, e.g., within a threshold distance of one another. This example is not to be construed as limiting, however, and the group context 136 may be detected in other manners without departing from the spirit or scope of the described techniques. For example, the group context 136 can be detected as users sharing content to a group presentation device (e.g., casting content to a smart TV), users participating in a shared messaging group or video call, users attending a virtual event together (e.g., participating in a shared video streaming session, attending a virtual watch party), users collaborating on a shared document or project, users gathered around a single device for content viewing, users simultaneously accessing the same content on separate devices within a shared network, users engaging in a synchronized content experience through a collaborative app, or users participating in a live online event or webinar together. In addition to detecting the group context 136, the content embedding system 130 includes functionality for identifying the particular users 124, 126, 128 participating in the group context 136.

The content embedding system 130 detects the group context 136 and the users 124, 126, 128 participating in the group context in a variety of ways. For instance, the devices 102, 104 may include cameras that enable facial recognition to identify multiple users in proximity. The content embedding system 130 may detect devices connected to the same Wi-Fi network or paired via Bluetooth, indicating a shared physical space. Additionally or alternatively, the content embedding system 130 may further receive GPS data from co-located devices to pinpoint users within the same vicinity. As part of this, the system 130 can associate device signatures of detected devices with corresponding device owners to identify the users 124, 126, 128. The content embedding system 130 may infer a group context 136 based on a content generation query (e.g., which prompts content generation by the generative AI model 134) that mentions or implies multiple viewers. Additionally, the devices 102, 104 may include microphones that capture audio clues (e.g., using speaker diarization techniques to distinguish between multiple speakers), further confirming a group setting. A virtual group setting (e.g., a group message, attending a virtual event, collaborating virtually on a shared document or project, etc.) by itself may indicate a group context 136, with participants of the virtual group setting representing the users participating in the group context 136. These methods, used individually or in combination, allow the content embedding system 130 to accurately detect and analyze group contexts 136 for content generation and embedding.

In addition, the content embedding system 130 receives a content generation query 138. Generally, the content generation query 138 is a natural language request submitted by a user providing information and/or instructions to the generative AI model 134 for creating the generated content 132. An example of a content generation query 138 is “generate an image of a stunning red car along an ocean drive.” Although the generated content 132 is depicted and described herein as generated by the generative AI model 134, it is to be appreciated that the generated content 132 is generated using any one or more of a variety of techniques and/or methods, examples of which include web scraping, database content retrieval (e.g., from stock image/video databases), and/or API-based content retrieval, e.g., from content repositories available at web sources.

In some implementations, the content generation query 138 is representative of a request to generate new content while the group context 136 is detected. Here, the generative AI model 134 generates new content (e.g., new generated content 132) by embedding the content element 120 corresponding to the shared characteristics of the group on the generated content 132. This request may be submitted by a user (e.g., the user 124 of the device 102) while the group context 136 is active.

In alternative implementations, the content generation query 138 is representative of a request to modify existing generated content 132. This request may correspond to sharing previously-generated content within the group context 136. For example, the previously generated content may have been created using the described techniques, but with an embedded content element 120 selected based on a particular user's characteristics (e.g., interests of the user 124) rather than the shared characteristics of the group. The request to modify may arise when sharing this content within the group context 136, such as sending the previously generated content to users in a group message or casting it to a smart TV while the group context 136 is detected. In this scenario, the content generation query 138 may be the original query that was submitted when the previously generated content was initially created. The generative AI model 134 then produces the generated content 132 by modifying the previously generated content, specifically by replacing the original content element (e.g., specific to the particular user 124) with a new content element 120 selected based on the shared characteristics of the users 124, 126, 128 in the current group context 136.

Upon receiving the content generation query 138, the content embedding system 130 is configured to analyze the content generation query 138 to identify a primary object of the content generation query 138. Generally, the primary object is a significant and/or central element of the content generation query 138 that is to be generated as part of the generated content 132. In the context of the previous example in which the content generation query 138 is “generate an image of a stunning red car along an ocean drive,” the primary object is “car.”

Responsive to identifying the primary object, the content embedding system 130 is configured to retrieve a plurality of content elements 120 associated with (e.g., relevant to) the primary object from the content database 118. Continuing with the previous example in which the primary object is “car,” the retrieved content elements 120 can include a plurality of brand logos of different car brands. In an additional example in which the primary object is “basketball player,” the retrieved content elements 120 can include a plurality of team logos of different professional basketball teams. As further discussed below, the retrieved content elements 120 can be related to the primary object itself or components of the primary object. In variations, the relevant content elements 120 can be retrieved from a local memory resource (e.g., memory 112 or memory 116), or from the remote service provider system.

In addition, the content embedding system 130 is configured to retrieve the user data 122 associated with the users 124, 126, 128 of the group context 136. In accordance with the described techniques, the content embedding process involves a primary user and one or more secondary users. Here, the primary user is the user that submits the content generation query 138 for new generated content, and/or initiates the request for content modification and adaptation to the group context 136. The secondary users, in contrast, are those that are detected as part of the group context 136, but do not initiate the content embedding process. Here, the primary user 124 initiates the content embedding process via the device 102 for consumption by the secondary users 126, 128.

Each user 124, 126, 128 is associated with user data 122, e.g., also referred to as each user's personal knowledge base (PKB). To obtain the user data 122 of the primary user 124, the content embedding system 130 retrieves the user data 122 of the primary user from a local memory resource (e.g., the memory 112 or the memory 116), or the content embedding system 130 can retrieve the user data 122 from the remote service provider system. The user data 122 of the secondary users 126, 128 is also obtainable in a variety of ways. In one example, the user data 122 of the primary user 124 (e.g., the primary user 124's PKB) also includes interests, preferences, and demographics of the secondary users 126, 128. Additionally or alternatively, the content embedding system 130 requests the user data 122 of the secondary users 126, 128 (e.g., the secondary users'PKBs) from devices (e.g., smartphones) associated with (e.g., owned by) the secondary users 126, 128, and the user data 122 is communicated over the network 106 from the secondary users'device(s) to the device 102 or the additional device 104. In yet another example, the content embedding system 130 retrieves the user data 122 of the secondary users 126, 128 from the remote service provider system.

Based at least in part on the user data 122 of the multiple users 124, 126, 128 in the group, the content embedding system 130 identifies one or more shared characteristics of the group, and selects a particular content element 120 from the retrieved content elements 120 based on the shared characteristics. In the context of a primary object detected as a car, the content embedding system 130 selects a brand logo of a particular car brand from a plurality of brand logos of a plurality of car brands. Here, the selected car brand is a shared interest of each user 124, 126, 128 (or a majority of the users 124, 126, 128) in the group. Additionally or alternatively, the particular brand logo is associated with an affordable car brand (based on the user data 122 indicating demographic information of a relatively low income level for each user or a majority of users in the group) or a luxury car brand (based on the user data 122 indicating demographic information of a relatively high income level for each user or a majority of users in the group). In the context of a primary object detected as a basketball player, for example, the content embedding system 130 selects a particular basketball team logo from a plurality of basketball team logos. Here, the particular team logo is associated with a professional basketball team that is a shared interest of each user 124, 126, 128 (or a majority of users 124, 126, 128) in the group.

Next, the content embedding system 130 prompts the generative AI model 134 to generate content by embedding the selected content element 120 on the primary object of the generated content 132. Broadly, the generative AI model 134 is a machine learning model trained to generate image content, video content, and/or audio content based on a prompt that includes the content generation query 138. Additionally or alternatively, the model 134 can produce generated content 132 by analyzing additional conditioning signals such as previously-generated content (with previously embedded content element(s) 120), the selected content element 120 to be embedded on the generated content 132, and/or an indication of the primary object on which to embed the selected content element 120. In various examples, the generative AI model 134 includes, but is not limited to including, generative adversarial networks (GANs), style transfer models (e.g., styleGAN), variational autoencoders, inpainting models, and diffusion models. In various examples, the generative AI model 134 includes or corresponds to a web platform that integrates a pre-trained large language model (LLM) (e.g., a generative pre-trained transformer (GPT-3) model) and a pre-trained multimodal model (e.g., a DALL-E 3 model), to process inputs and outputs in different content modalities, e.g., image, text, video, and/or audio.

As used herein, the term “machine learning model” refers to a computer representation that is tunable (e.g., trainable) based on inputs to approximate unknown functions. By way of example, the term “machine learning model” includes a model that utilizes algorithms to learn from, and make predictions on, known data by analyzing the known data to learn to generate outputs that reflect patterns and attributes of the known data. According to various implementations, such a machine learning model uses supervised learning, semi-supervised learning, unsupervised learning, reinforcement learning, and/or transfer learning. For example, a machine learning model is capable of including, but is not limited to, clustering, decision trees, support vector machines, linear regression, logistic regression, Bayesian networks, random forest learning, dimensionality reduction algorithms, boosting algorithms, artificial neural networks (e.g., fully-connected neural networks, deep convolutional neural networks, or recurrent neural networks), deep learning, etc. By way of example, a machine learning model makes high-level abstractions in data by generating data-driven predictions or decisions from the known input data.

In accordance with the described techniques, the content embedding system 130 generates a prompt that includes the content generation query 138, an indication of the primary object, the selected content element 120, and/or the previously generated content. The prompt instructs the generative AI model 134 to embed the selected content element 120 on the primary object. When generating new generated content, the generative AI model 134 produces generated content 132 in accordance with the content generation query 138 such that the selected content element 120 (e.g., corresponding to the shared characteristics) is embedded on the primary object. When modifying existing generated content, the prompt instructs the generative AI model 134 to replace an existing content element 120 embedded on the previously generated content with the selected content element 120, e.g., corresponding to the shared group characteristics. Here, the generative AI model 134 generates content based on the content generation query 138 by modifying the previously generated content to replace the existing content element 120 and/or modify the placement of the selected content element 120 on the primary object.

In one or more implementations, the device 102 is configured to produce the generated content 132 locally at the device 102. For example, the device 102 includes the generative AI model 134 (e.g., maintained in memory 112), and the device 102 leverages the content embedding system 130a and the generative AI model 134 to produce the generated content 132 at the device 102. In this example, the content generation query 138 is received (or the content modification request is initiated) at the device 102, the prompt is generated at the device 102, and the generated content 132 is created at the device 102.

Additionally or alternatively, the device 102 employs the additional device 104 to produce the generated content 132. In various scenarios, for instance, the additional device 104 is configured with increased processing and/or memory resources as compared to the device 102. For example, the additional device 104 includes increased memory capacity as compared to the device 102, and as such, the generative AI model 134 is capable of being stored at the additional device 104 but not the device 102. In another example, the additional device 104 includes additional and/or more processing resources than the device 102, and as such, implementing the generative AI model 134 at the additional device 104 reduces content generation latency, e.g., a time between when the content generation query 138 is submitted and when the generated content 132 is output. For instance, the additional device 104 is equipped with accelerator devices designed to speed up execution of machine learning workloads (e.g., neural processing units (NPUs), inference processors, and the like), while the device 102 is not equipped with such accelerator devices. This enables the additional device 104 to produce the generated content 132 using the generative AI model 134 significantly faster than the device 102.

Accordingly, in various implementations, the device 102 is configured to offload the content generation task to the additional device 104. In one example, the device 102 receives the content generation query 138 (or initiates the content modification request), and leverages the content embedding system 130a to identify the primary object, select the content element 120 for embedding, and generate the prompt. Further, the device 102 communicates the prompt to the additional device 104. Here, the additional device 104 leverages the generative AI model 134 (e.g., maintained in memory 116 of the additional device 104) to produce the generated content 132 based on the prompt, and communicates the generated content 132 back to the device 102, e.g., for display in a user interface. In other words, the content generation query 138 is received (or the content modification request is initiated) at the device 102, the prompt is generated at the device 102, and the generated content 132 is created at the additional device 104.

In another example, the device 102 receives the content generation query 138 (or initiates the content modification request), and communicates the content generation query 138 (and/or the previously generated content) to the additional device 104. Here, the additional device 104 employs the content embedding system 130b and the generative AI model 134 (e.g., maintained in memory 116 of the additional device 104) to identify the primary object, select the content element 120 for embedding, generate the prompt, create the generated content 132 using the generative AI model 134, and communicate the generated content 132 back to the device 102, e.g., for display. In other words, the content generation query 138 is received (or the content modification request is received) at the device 102, the prompt is generated at the additional device 104, the generated content 132 is created at the additional device 104, and the generated content 132 is communicated for output at the device 102.

By offloading the content generation task to the additional device 104 in the manner described, the described techniques enable and/or speed up the process of producing the generated content 132. In an example in which there is insufficient memory 112 to store the generative AI model 134 at the device 102, for instance, the described offloading techniques enable the additional device 104 to create the generated content 132 for the device 102. In another example in which the additional device 104 includes increased processing capabilities as compared to the device 102, the described offloading techniques reduce the content generation latency as compared to producing the generated content 132 at the device 102.

In yet another example, an instance of the content embedding system 130 is implemented at the remote service provider system, which provides the functionality and resources of the content embedding system 130 to the device 102 over the cloud. For example, the device 102 receives the content generation query 138 (or initiates the content modification requests) and communicates the content generation query 138 (and/or the previously generated content) to the remote service provider system. Here, the remote service provider system employs the content embedding system 130 and the generative AI model 134 (e.g., implemented at the remote service provider system) to identify the primary object, select the content element 120 for embedding, generate the prompt, create the generated content 132 using the generative AI model 134, and communicate the generated content 132 back to the device 102, e.g., for display.

Having discussed an example environment in which the disclosed techniques can be performed, consider now some example scenarios and implementation details for implementing the disclosed techniques.

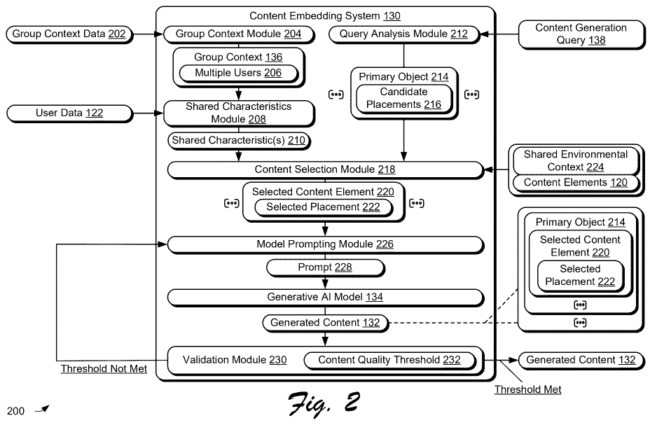

FIG. 2 illustrates an example system 200 for embedding content on generated content for a group audience. In the system 200, a content embedding system 130 is configured to receive group context data 202, which generally is any data usable by a group context module 204 to detect a group context 136 in which multiple users 206 are consuming content together. In variations, the content embedding system 130 of the system 200 is the content embedding system 130a of the device 102, the content embedding system 130b of the additional device 104, or an instance of the content embedding system 130 implemented by the remote service provider system.

As further discussed above, the group context data 202 may include facial recognition data from device cameras, device connectivity information such as shared Wi-Fi or Bluetooth connections, GPS location data indicating physical proximity, calendar event data suggesting shared activities, social media interaction data, video call participation data, group message participation data, collaborative app usage information, synchronized content streaming data, and audio data processed through speaker diarization techniques. The group context module 204 may analyze this diverse set of inputs to accurately identify scenarios where multiple users are likely to be consuming content as a group, whether in physical proximity or through various forms of virtual interaction and shared digital experiences.

In one example, the group context module 204 detects, as the group context 136, multiple users co-located at a same physical location, e.g., within a threshold distance of one another. This may be accomplished by analyzing audio data using speaker diarization techniques or facial recognition data to uniquely identify the multiple users 206, detecting multiple devices (and their device signatures associated with different users) connected to the same local Wi-Fi network, or using Bluetooth Low Energy (BLE) signals to identify nearby devices (and their device signatures associated with different users).

In another example, the group context module 204 detects, as the group context 136, a user of the device 102, 104 casting content to a group presentation device, e.g., a smart TV. To detect the multiple users 206 participating in the group context 136, the group context module 204 may detect multiple mobile devices connected to the TV's local network. Additionally or alternatively, the group context module 204 analyzes interaction data from multiple user accounts or devices simultaneously engaging with the casted content, e.g., different users providing input or feedback through their personal devices while viewing the shared content on the smart TV. Additionally, the group context module 204 may analyze audio data collected by microphones in the device 102, the additional device 104, the smart TV, or other connected smart home devices, using speaker diariation techniques to distinguish between multiple voices in the vicinity. The group context module 204 may also leverage cameras in the device 102, additional device 104, smart TV, or other smart home devices to perform facial recognition, identifying different users present in the viewing area. Furthermore, motion sensors in connected smart home devices could be used to detect the presence and movement patterns of multiple individuals.

In yet another example, the group context module 204 detects, as the group context 136, a user of the device 102, 104 sharing content to the multiple users 206 in a messaging group. Here, the group context 136 may be detected when a particular user shares previously generated content (e.g., generated in accordance with the described techniques based on the particular user's user data 122 and/or characteristics) to a group chat. In this scenario, the users participating in the messaging group are the multiple users 206 of the group context 136.

As shown, a shared characteristics module 208 is configured to identify one or more shared characteristics 210 of the multiple users. This is achieved by collecting user data 122 of the multiple users 206, which can be done in a variety of ways, as further discussed above. The shared characteristics module 208 identifies shared characteristics 210 (e.g., shared interests, preferences, and/or demographics of the multiple users 206) by analyzing the user data 122.

In accordance with the describes techniques, a query analysis module 212 of the content embedding system 130 receives a content generation query 138. As previously mentioned, the query may correspond to a request to generate new content or a request to modify previously generated content to adapt it for a group audience.

The query analysis module 212 is representative of functionality for extracting one or more primary objects 214 from the content generation query 138. Additionally, the query analysis module 212 is configured to identify, for each primary object 214, one or more candidate placements 216 on the primary object 214 where content elements 120 are embeddable. As previously mentioned, the primary object 214 is a significant and/or central element of the content generation query 138, and there can be more than one primary object 214 in a single content generation query 138. The candidate placements 216 include the primary object 214 as a whole, and components of the primary object 214. In an example of a “car” as a primary object 214, for instance, the candidate placements 216 include the car as a whole, tires of the car, a grill of the car, an exhaust pipe of the car, an engine of the car, and so on. Additionally or alternatively, the candidate placements 216 include components that are non-essential for fully illustrating the primary object 214 but can be added, superimposed, and/or integrated as part of the primary object 214. In an example of a “cat” as a primary object, for instance, the cat can be made to wear a jacket, shoes, and sunglasses. Accordingly, the candidate placements 216 include jacket, shoes, and sunglasses to be worn by the cat even though the final generated content 132 may not include each of the jacket, the shoes, and the sunglasses.

Any one or more of a variety of public or proprietary natural language processing (NLP) techniques are usable by the query analysis module 212 to extract the primary objects 214 and the candidate placements 216 thereon. Example techniques include named entity recognition (NER), keyword extraction, semantic analysis, part-of-speech (POS) tagging, and the like. Additionally or alternatively, the query analysis module 212 leverages an LLM that has been pre-trained to perform a variety of NLP tasks, such as query and/or prompt answering, examples of which include generative pre-trained transformer (GPT) models, text-to-text transfer (T5) models, bidirectional encoder representations from transformers (BERT) models, and the like. By way of example, the query analysis module 212 communicates with the LLM using an application programming interface (API) to prompt the LLM to extract the primary objects 214 from the content generation query 138, and/or identify the candidate placements 216 thereon.

As shown, a content selection module 218 receives the shared characteristics 210, the primary objects 214, and the candidate placements 216. Broadly, the content selection module 218 is representative of functionality for selecting one or more content elements 120 (e.g., selected content elements 220) to embed on the primary object(s) 214. The content selection module 218 is further configured to select, for each selected content element 220, a placement from the candidate placements 216 (e.g., the selected placement 222) on which to embed the selected content element 220.

As part of this, the content selection module 218 retrieves a plurality of content elements 120 associated with the primary object(s) 214 from the content database 118. In one or more examples, each content element 120 in the content database 118 is paired with a set of tags associated with the content element 120. Tags, for instance, are key words or key phrases associated with the content element 120. In the context of an example in which the content element 120 is a brand logo, the tags paired with the brand logo include products or services offered by the brand. For instance, a fashion brand logo is paired with tags describing types of clothing products that the fashion brand offers, such as “shirt,” “shoes,” “jacket,” and so on. In the context of an example in which the content element 120 is a logo of a sports team, examples of tags include the city where the sports team is located, the particular sport that the team plays, the mascot of the team, and so on.

Given this, the content selection module 218 queries the content database with the candidate placements 216, e.g., the primary object 214 and the components of the primary object 214. In response, the content database 118 returns the content elements 120 that are paired with the candidate placements 216 as tags in the content database 118. In an example in which the candidate placements 216 include “jacket,” for instance, the retrieved content elements 120 include content elements 120 that are paired with the tag “jacket” in the content database 118. In this way, the content selection module 218 retrieves content elements 120 that are relevant to the primary object 214.

Additionally or alternatively, the content selection module 218 obtains a shared environmental context 224 associated with the multiple users 206. Broadly, the shared environmental context 224 includes external factors and conditions surrounding the multiple users 126 that (1) impact the relevance of the retrieved content elements 120, and (2) are shared by each of (or a majority of) the multiple users 206. For example, the environmental context 224 includes a shared geographic location of the multiple users 206 (e.g., as obtained from GPS sensors of user-specific devices and/or location tracking services), and various contextual factors associated with the shared geographic location, e.g., a time of day, seasonality, weather conditions, local events or promotions happening near the shared location, and so on.

In one or more examples, the retrieved content elements 120 include branded content (e.g., brand logos, brand icons, brand advertisements, brand promotions, brand commercials, etc.) of a plurality of brands. As part of retrieving the branded content elements 120, the content selection module 218 is configured to retrieve information associated with the brand from the content database 118. For example, each branded content element 120 is paired with brand information in the content database 118, and the content selection module 218 retrieves the brand information as part of retrieving the branded content element 120. Examples of brand information of a branded content element 120 include promotions offered by a corresponding brand, a brand voice of the corresponding brand (e.g., a statement of the unique personality, tone, and style that a brand consistently uses to communicate with the brand's audience, reflecting the brand's values, mission, and identity), endorsements of the corresponding brand (e.g., indications of public figures, like celebrities or influencers, that promote the brand by expressing personal approval of the brand's products or services), campaign objectives of the corresponding brand (e.g., goals of the brand's advertising campaign, such as increasing brand awareness, generating leads, enhancing customer engagement, or promoting a new product or service), and sponsorships of the brand, e.g., events, organizations, and political campaigns that the brand provides financial or other support to for the purpose of enhancing brand visibility.

Broadly, the content selection module 218 is configured to output the selected content elements 220 from the retrieved content elements 120, and output the selected placement 222 for each content element 220 from the candidate placements 216. This selection is based on the shared characteristics 210, the shared environmental context 224, the content generation query 138, and/or the brand information of the corresponding brands. In various examples, the content selection module 218 employs a machine learning model for this task. In one or more implementations, the content selection module 218 communicates (via an API) with a web platform that integrates a pre-trained LLM and a multimodal model, to process inputs and outputs in different content modalities, e.g., image, text, video, and/or audio. As part of this, the content selection module 218 prompts the web platform to select a content element from the retrieved content elements 120, and select a placement from the candidate placements 216 based on the shared characteristics 210, the shared environmental context 224, the content generation query 138, and/or the brand information.

For example, the content selection module 218 populates a first preconfigured prompt with indications of the retrieved content elements 120, the shared characteristics 210, the shared environmental context 224, the content generation query 138, and/or the brand information. In this example, the first preconfigured prompt instructs the web platform to select a particular content element from the retrieved content elements 120 that exhibits a highest degree of relevance to the shared characteristics 210, the shared environmental context 224, the content generation query 138, and/or the brand information. Here, the content selection module 218 feeds the first preconfigured prompt as populated with the above-noted information to the web platform, which returns the selected content element(s) 220 along with the selected placement(s) 222.

In one or more implementations, the first preconfigured prompt includes specific instructions for processing the brand information. These instructions may direct the platform to select a branded content element 120 based on (1) whether the brand information includes promotional offers that are relevant to the content generation query 138 (e.g., promotional offers for the primary object 214 or the candidate placements 216) or the shared characteristics 210, (2) whether the brand information includes a brand voice that aligns with the content generation query 138 or the shared characteristics 210, (3) whether the brand information includes endorsements of the brand that are relevant to shared user interests of the shared characteristics 210, (4), whether surfacing the branded content element 120 to the multiple users 206 will further the campaign objectives of the brand based on the shared characteristics 210, and (5) whether the brand information includes sponsorships that are relevant to the shared characteristics 210.

Furthermore, the content selection module 218 populates a second preconfigured prompt with indications of the candidate placements 216 and the selected content element 220. In this example, the second preconfigured prompt instructs the web platform to select a particular placement from the candidate placements 216 that exhibits a highest degree of relevance to the selected content element 220. Here, the content selection module 218 feeds the second preconfigured prompt as populated with the above-noted information to the web platform, which returns the selected placement 222.

In a different example, a machine learning model is specifically trained and/or finetuned on a dataset for the purpose of outputting the selected content elements 220 and the selected placements 222 thereon. Here, the training dataset includes a plurality of training samples, each including training input data and corresponding labels. The training input data of a training sample includes a content generation query 138, a set of content elements 120, brand information of branded content elements 120 in the set, shared characteristics 210 of a set of users, and a shared environmental context 224. Further, the corresponding labels include ground truth content elements that are selected by human annotators as most relevant to the brand information (e.g., considering factors (1)-(5) indicated above), the shared characteristics 210, the shared environmental context 224, and/or the content generation query 138. In addition, the corresponding labels include a ground truth placement on each ground truth content element that is selected by human annotators as most relevant to the ground truth content element.

During training, the machine learning model is fed a training sample. Based on the training input data of the training sample, the machine learning model outputs one or more selected content elements 220 and a selected placement 222 on each selected content element 220. Furthermore, a loss function is leveraged to determine a loss between the selected content elements 220 and the ground truth content elements, as well as between the selected placements 222 and the ground truth placements. In one or more implementations, vectorization techniques are employed to vectorize the selected content elements 220, the selected placements 222, the ground truth content elements, and the ground truth placements in a common embedding space. In this way, the loss is computable based on distances (e.g., Euclidean distance) between the selected content elements 220 and the ground truth content elements, as well as between the selected placements 222 and the ground truth placements. Parameters (e.g., internal weights) of the machine learning model are updated to minimize the loss. This process is repeated on different training samples until a threshold number of training samples are processed, a threshold number of epochs are processed, or the loss converges to a minimum. In this way, the machine learning model learns to select content elements, and placements thereon that reflect the ground truth content elements and placements in the training data.

As shown, the model prompting module 226 receives the selected content elements 220 and the selected placements 222 thereon. Although not shown, the model prompting module 226 additionally receives the content generation query 138, indications of the primary objects 214, and/or the previously generated content. In a new content generation request, the model prompting module 226 generates a prompt 228 by populating a preconfigured prompt with the primary objects 214, the selected content elements 220, the selected placements 222, and the content generation query 138. Here, the prompt 228 instructs the generative AI model 134 to generate content in accordance with the content generation query 138, and embed the selected content elements 220 on the selected placements 222 of the primary object 214.

In a content modification request, the model prompting module 226 generates a prompt 228 by populating a preconfigured prompt with the previously generated content (including previously embedded content element(s) 120), the primary objects 214, the selected content elements 220, and the selected placements 222. Here, the prompt 228 instructs the generative AI model 134 to modify the previously generated content by replacing the previously embedded content element(s) with the selected content elements 220, and embedding the selected content elements 220 on the selected placements 222.

In response to the prompt 228, the generative AI model 134 creates generated content 132. As shown, the generated content 132 includes one or more primary objects 214. Given a primary object 214, the generated content 132 includes one or more selected content elements 220 embedded thereon. In particular, each selected content element 220 is embedded on a selected placement 222 for the primary object 214. In various examples, the generated content 132 is generated in accordance with a style of the selected content element 220. Consider an example in which the primary object 214 is a “jacket” and the selected content element 220 is a brand logo of a fashion brand. In this example, the prompt 228 additionally includes an instruction to generate (and/or modify the jacket of the previously generated content) in accordance with a style of the particular fashion brand, and as such, the jacket is generated in the style of the fashion brand, e.g., the selected content element 220. In content modification scenarios, the generated content 132 includes selected content elements 220 that differ from the previously embedded content element(s), and the selected placements 222 can differ from locations where the previously embedded content elements were previously embedded.

As shown, the generated content 132 is provided to a validation module 230, which is configured to control output of the generated content 132 based on whether the generated content 132 satisfies an image quality threshold 232. To do so, the validation module 230 uses an image quality scoring algorithm to determine an image quality score for the generated content 132. As part of this, the generative AI model 134 is configured to generate an image of the generated content 132, and a duplicate image of the generated content 132 that does not include the content elements embedded thereon. Given this, the image quality scoring algorithm considers a peak signal-to-noise ratio (PSNR) which compares a first image (e.g., the image of the generated content 132) to a second image (e.g., the duplicated image that excludes the selected content elements 220) to determine an amount of noise or distortion that is present in the first image. Additionally or alternatively, the image scoring algorithm considers a structural similarity index measure (SSIM) which measures a human-perceived similarity between a first image (e.g., the image of the generated content 132) to a second image, e.g., the duplicated image that excludes the selected content elements 220. In various examples, the image quality scoring algorithm considers an inception score for an image of the generated content 132, which measures quality and diversity of images generated by the generative AI model.

Additionally or alternatively, the image scoring algorithm leverages a visual saliency model, which is configured to produce a visual saliency map of an image of the generated content 132. A visual saliency map captures degrees of fixation by human observers on corresponding portions of an image. For example, brighter regions of the visual saliency map correspond to areas of the image that are more visually prominent, while darker regions of the visual saliency map correspond to areas of the image that are less visually prominent. In one or more examples, brightness is measured in luminance on a scale between zero and two-hundred fifty-five. Here, a particular degree of fixation is desired for the content elements embedded on the primary object 214. Indeed, it is desirable for the embedded content element to be noticed by the user, but not to distract the user from the remainder of the generated content 132. Accordingly, a preferred value of luminance is specified (e.g., more than zero but less than two-hundred fifty-five), and an exhibited value of luminance is determined for the region of the visual saliency map corresponding to the selected content element 220. The image quality score is based on how close the exhibited value of luminance is to the preferred value of luminance, e.g., with closer scores being assigned higher image quality scores.

Accordingly, the image scoring algorithm generates an image quality score for the generated content 132 using PSNR, SSIM, inception score, and/or visual saliency maps. Next, the validation module 230 compares the image quality score to the image quality threshold 232, e.g., a threshold value for the image quality score. If the image quality score satisfies the image quality threshold 232, then the generated content 132 is output, as shown. If, however, the image quality score does not satisfy the image quality threshold 232, then the validation module 230 causes the content embedding system 130 to iteratively re-produce different generated content 132 until generated content 132 is produced that satisfies the image quality threshold 232. In the following discussion, consider an example of generated content 132 having one primary object 214 and one selected content element 220 embedded on the selected placement 222 of the primary object 214.

During one or more first iterations, the validation module 230 instructs the model prompting module 226 to re-prompt the generative AI model 134 on the same input. In other words, the model prompting module 226, during the first iterations, prompts the generative AI model 134 to create the generated content 132 by embedding the same selected content element 220 on the same selected placement 222 of the primary object 214. During each iteration, the generated content 132 is assigned an image quality score, which is compared against the image quality threshold 232. If the image quality threshold 232 is satisfied during a particular first iteration, then the generated content 132 created during the particular first iteration is output.

After a threshold number of the first iterations (e.g., three iterations) have failed to produce generated content 132 that satisfies the image quality threshold 232, the validation module 230 instructs the content selection module 218 to select a different content element (from the retrieved content elements 120) and/or select a different placement on the primary object 214. Thus, during each of the second iterations, the model prompting module 226 prompts the generative AI model 134 to create the generated content 132 by embedding a different content element on a different placement of the primary object 214. Notably, different ones of the second iterations embed different content elements 120 on the primary object 214. If the image quality threshold 232 is satisfied during a particular second iteration, then the generated content 132 created during the particular second iteration is output.

After a threshold number of the second iterations (e.g., three iterations) have failed to produce generated content 132 that satisfies the image quality threshold 232, the validation module 230 instructs the model prompting module 226 to re-prompt the generative AI model 134 to generate content without a content element 120 from the content database 118. For example, the model prompting module 226 instructs the generative AI model 134 to create generated content 132 based on the content generation query 138 without imposing an instruction to embed a content element 120 on the primary object 214. Here, the generated content 132 that does not include a content element 120 from the content database 118 is output for display in the user interface regardless of image quality score. In content modification scenarios, the content embedding system 130 outputs an unmodified version of the previously generated content after the threshold number second iterations have failed.

In one or more implementations, the user provides feedback via user input (e.g., to a user interface) with respect to the generated content 132. In one example, the content embedding system 130 displays a prompt in the user interface along with the generated content 132. Here, the prompt asks whether the selected content element 220 is relevant to the multiple users 206. If the multiple users 206 provide positive feedback (i.e., indicating that the selected content element 220 is relevant), then no further action is taken. However, if the multiple users 206 provide negative feedback (i.e., indicating that the selected content element 220 is not relevant), then the content selection module 218 is configured to select a different content element (from the retrieved content elements 120) to embed on the primary object 214. Furthermore, the model prompting module 226 prompts the generative AI model 134 to create generated content 132 by embedding a different content element on the primary object 214.

Additionally or alternatively, the feedback provided by the multiple users 206 is usable to further train and/or refine the machine learning model implemented by the content selection module 218. In response to receiving the positive feedback from the users 206, for instance, the content embedding system 130 positively reinforces (e.g., rewards) the machine learning model. Alternatively, the content embedding system 130 negatively reinforces (e.g., penalizes) the machine learning model in response to receiving the negative feedback from the users 206. In this way, the machine learning model continues to learn (e.g., using reinforcement learning) how to select relevant and appropriate content elements for users during deployment, which improves content element selection accuracy.

In one or more implementations, the query analysis module 212 determines the primary object 214 and candidate placements 216 by analyzing the content generation query 138, as discussed above. Additionally or alternatively, the generative AI model 134 is employed to generate intermediate content (e.g., without embedded content elements) based on the content generation query 138, and the system 130 analyzes the intermediate content to determine the primary object 214 and candidate placements 216. In this situation, the generative AI model 134 is prompted to re-generate the intermediate content while embedding the selected content elements 220 on the selected placements 222, e.g., thereby creating the final generated content 132.

It should be noted that the content embedding system 130 is capable of modifying the previously generated content (e.g., via content element 120 replacement) in response to various triggers. As discussed, one trigger can be sharing of the previously generated content while the group context 136 is detected. In a group message scenario, the previously generated content is modified based on the shared characteristics 210 and shared environmental context 224 of the multiple users 206, as previously mentioned. In direct messaging scenarios (e.g., in which the previously generated content is shared/sent to a single recipient), the previously generated content is modified based on user data 122 of the single recipient. Another trigger is a context change in which the previously generated content includes content elements 120 embedded thereon that were selected based on a particular environmental context, and the content is retrieved (e.g., for viewing) at a later time when the environmental context has changed. Here, the content embedding system 130 modifies the previously generated content to include new content element(s) selected based on the updated environmental context. Another trigger is a promotion expiration in which the previously generated content includes content elements 120 embedded thereon that were selected based on a promotional offer, and the content is retrieved (e.g., for viewing) at a later time when the promotional offer has expired. Here, the content embedding system 130 modifies the previously generated content to include new content element(s), e.g., reflective of an active promotional offer.

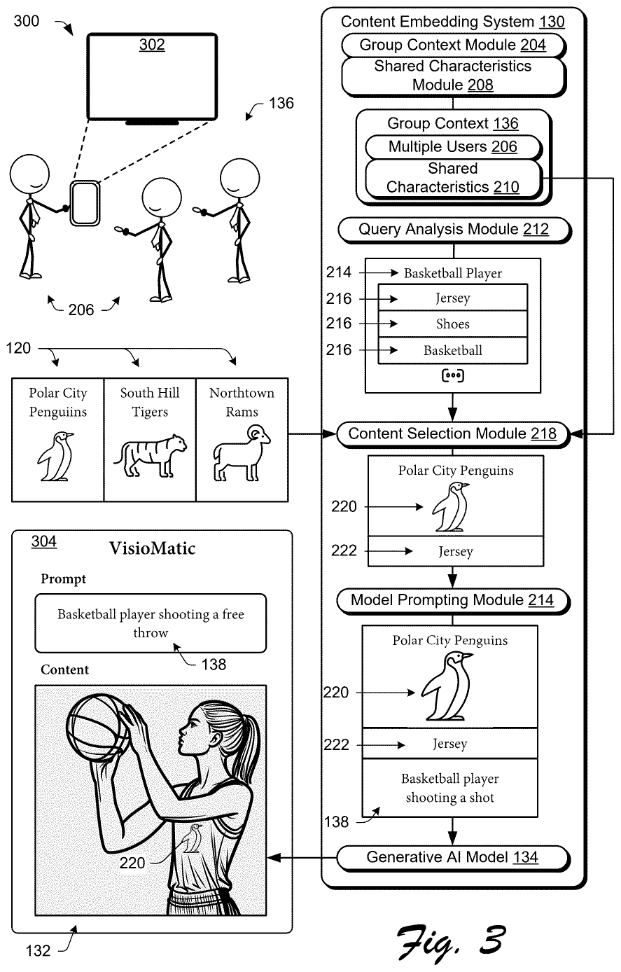

FIG. 3 depicts an example 300 of embedding content on generated content for a group audience. As shown, the group context module 204 detects, as the group context 136, a user casting content to a group presentation device 302 (e.g., a smart TV) in the presence of multiple users 206. In addition, the shared characteristics module 208 identifies shared characteristics 210 of the multiple users 206, which in this example, includes a shared interest in a basketball team, e.g., the “Polar City Penguins.”

In addition, the content embedding system 130 receives a content generation query 138 “basketball player shooting a free throw.” Here, the content generation query 138 is received as a request to generate new content 132 for consumption by the multiple users 206 of the group context 136. The content generation query 138 is provided to the query analysis module 212, which extracts the primary object 214 and candidate placements 216 thereon. Here, the primary object 214 is “basketball player,” and the candidate placements 216 include the basketball player as a whole and components of the basketball player, such as “jersey,” “shoes,” and “basketball.”

As shown, the content selection module 218 retrieves a plurality of query-relevant content elements 120 including team logos of professional basketball teams, e.g., “Polar City Penguins,” “South Hill Tigers,” and “Northtown Rams.” These content elements 120, for instance, are paired with the tag “basketball” in the content database. In addition, the content selection module 218 receives the shared characteristics 210.

Here, the content selection module 218 outputs a selected content element 220, e.g., a team logo of “Polar City Penguins.” In one example, a women's basketball team is chosen based on the shared characteristics 210 indicating that the multiple users 206 are women. Additionally or alternatively, the team “Polar City Penguins” is chosen based on the shared environmental context 224 of the multiple users 206 indicating that the Polar City Penguins play a game within a certain time frame (e.g., within the next twelve hours) and that the multiple users 206 are within a certain distance radius (e.g., ten miles) from a stadium where the Polar City Penguins play. Additionally or alternatively, the team “Polar City Penguins” is selected based on the shared characteristics 210 indicating a common interest in the team. The selection module 218 further outputs the “jersey” as the selected placement 222 on the primary object 214, e.g., based on a degree of relevance of a basketball jersey with respect to a professional basketball team.

Next, the model prompting module 226 builds a prompt to feed to the generative AI model 134. The prompt includes the selected content element 220, the selected placement 222 on the primary object 214, and the content generation query 138. As shown, the generative AI model 134 creates generated content 132 based on the prompt by embedding the selected content element 220 (e.g., the team logo of the Polar City Penguins) on the selected placement 222 (e.g., the jersey) of the primary object 214, e.g., the basketball player. The generated content 132 is output for display in a user interface 304.

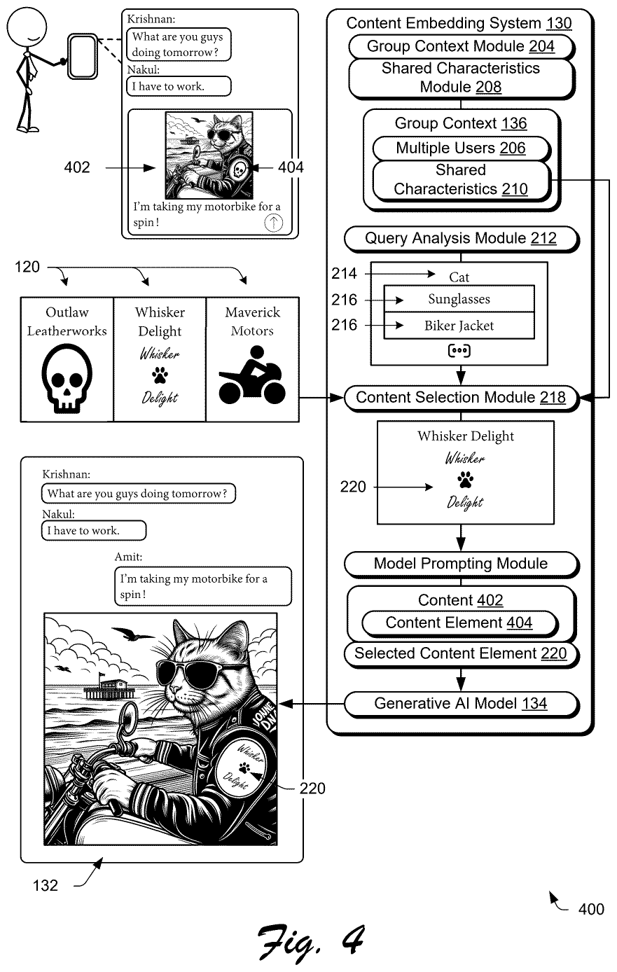

FIG. 4 depicts an example 400 of embedding content on generated content for a group audience. As shown, the group context module 204 detects, as the group context 136, a user sharing previously generated content 402 to a messaging group including multiple users 206, e.g., Krishnan, Nakul, and Amit. Here, the previously generated content 402 includes a first content element 404 (e.g., a logo for the brand “Outlaw Leatherworks), which was selected for embedding on the content 402 based on the user data of a particular user, e.g., the primary user sharing the previously generated content to the messaging group. Given this, the sharing of the previously generated content 402 is representative of a request to modify the previously generated content 402 to adapt it for the multiple users 206 of the group context 136. In addition, the shared characteristics module 208 identifies shared characteristics 210 of the multiple users 206, which in this example, includes a shared interest in cats and/or pets.

In addition, the content embedding system 130 receives a content generation query 138 “cat riding a motorcycle along an ocean drive.” Here, the previously generated content 402 includes metadata of the content generation query 138 as originally submitted in order to generate the previously generated content 402. Thus, the content generation query 138 is extracted from the metadata and provided to the query analysis module 212, which extracts the primary objects 214 and candidate placements 216 thereon in accordance with the described techniques. As shown, the primary objects 214 include “cat” and “motorcycle” (not shown). The candidate placements 216 for “cat” include the primary object 214 itself, as well as components that the cat can be made to wear, such as “sunglasses” and “biker jacket.” Further, the candidate placements 216 for “motorcycle” include the primary object 214 itself, as well as components of the motorcycle, such as “wheels” and “exhaust pipe.”

As shown, the content selection module 218 retrieves a plurality of content elements 120 including brand logos of a plurality of brands, e.g., Outlaw Leatherworks, Whisker Delight, and Maverick Motors. For example, the clothing brand “Outlaw Leatherworks” is paired with the tag “biker jacket” in the content database 118, the cat food brand “Whisker Delights” is paired with the tag “cat” in the content database 118, and the motorcycle brand “Maverick Motors” is paired with the tag “motorcycle” in the content database 118. In addition, the content selection module 218 receives the shared characteristics 210, as shown.

Here, the content selection module 218 outputs, from the retrieved content elements 120, a selected content element 220, e.g., the brand logo of “Whisker Delights.” In one example, the cat food brand is selected based on the shared characteristics indicating a stronger interest of the multiple users 206 in “pets” or “cats,” as compared to “automobiles” and “fashion.” Additionally or alternatively, “Whisker Delight” is chosen based on the shared environmental context 224 indicating that the multiple users 206 are within a threshold radius (e.g., five miles) of a brick-and-mortar store offering “Whisker Delights” products for sale and/or offering a promotion for “Whisker Delights” products, e.g., buy one get one free. Additionally or alternatively, “Whisker Delights” is chosen based on brand information of “Whisker Delights” indicating a sponsorship with an organization in which the multiple users 206 have a shared interest.

Next, the model prompting module 226 builds a prompt 228 to feed to the generative AI model 134. The prompt includes the previously generated content 402 having the content element 404, as well as the selected content element 220 for replacement. As shown, the generative AI model 134 creates generated content 132 based on the prompt by replacing the content element 404 (e.g., the brand logo of Outlaw Leatherworks) with the selected content element 220 (e.g., the brand logo of Whisker Delight) on the primary object 214, e.g., the cat. Although depicted as embedding the content element 220 on the same placement as the original content element 404, the content embedding system 130 can embed the selected content element 220 on a different selected placement 222 in accordance with the described techniques.

As shown, the content embedding system 130 outputs the generated content 132 (e.g., the modified content) as a message to the group chat. For instance, the primary user crafts the message to the group including the previously generated content 402. In response to receiving user input to send the message, the content embedding system 130 processes the previously generated content 402 to adapt it for the group audience in accordance with the described techniques. Further, the message is communicated to the group, and the message includes the modified content rather than the previously generated content 402.

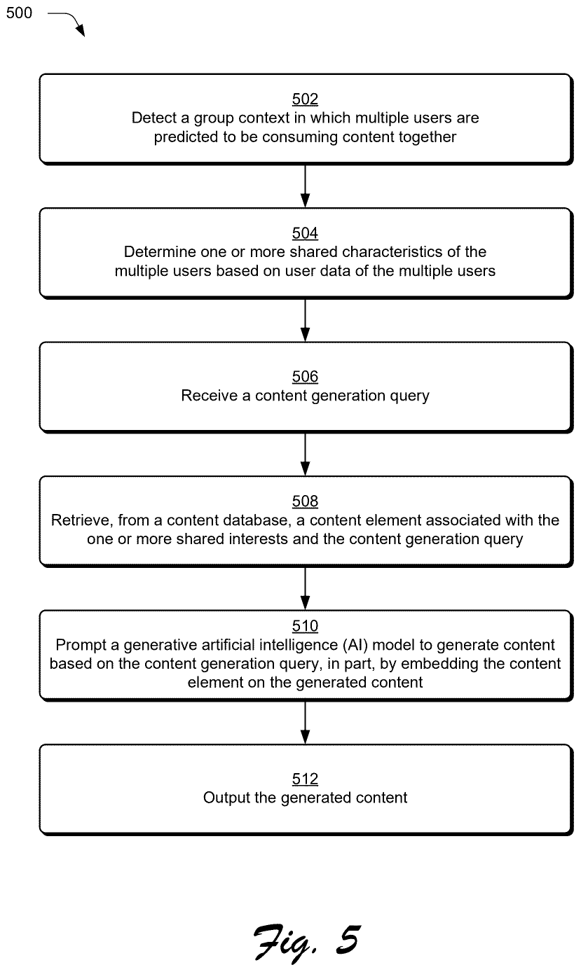

FIG. 5 illustrates a flow chart depicting an example method 500 of embedding content on generated content for a group audience in accordance with one or more implementations. At 502, a group context is detected in which multiple users are predicted to be consuming content together. For example, the group context module 204 detects, based on the group context data 202, a group context 136 in which multiple users 206 are predicted to be consuming content together, e.g., sharing content to a group presentation device in the presence of the multiple users 206.

At 504, one or more shared characteristics of the multiple users are determined based on user data of the multiple users. For example, the shared characteristics module 208 determines one or more shared characteristics of the multiple users 206 based on user data 122 of the multiple users. The one or more shared characteristics include shared interests, shared preferences, and/or shared demographic information of the multiple users 206 in various implementations.

At 506, a content generation query is received. In the example method 500, the content generation query 138 is received as part of a request to generate new content within the group context 136.

At 508, a content element is retrieved from a content database, and the content element is associated with the one or more shared interests and the content generation query. For example, the query analysis module 212 analyzes the content generation query 138 to identify the primary objects 214 of the query, and the candidate placements 216 on the primary objects 214 (e.g., the primary object 214 itself or components of the primary object 214) where content elements 120 are embeddable. Further, the content selection module 218 retrieves content elements 120 that are relevant to the candidate placements 216. This is done by querying the content database 118 with the candidate placements 216, and retrieving the content elements 120 paired with the candidate placements 216 in the content database 118. From the relevant content elements 120, the content selection module 218 outputs a selected content element 220 based on the shared characteristics 210, e.g., the selected content element 220 is associated with an interest shared by all or a majority of the multiple users 206. In addition, the content selection module 218 outputs a selected placement 222 indicating where to embed the selected content element 220 based on a degree of relevance of the selected placement 222 to the selected content element 220.

At 510, a generative AI model is prompted to generate content based on the content generation query, in part, by embedding the content element on the generated content. By way of example, the model prompting module 226 builds a prompt 228 that includes the content generation query 138, the selected content element 220, and the selected placement 222. Here, the prompt instructs the generative AI model 134 to create generated content 132 in accordance with the content generation prompt 138, and embed the selected content element 220 on the selected placement 222 of the primary object 214. At 512, the generated content is output. For example, the generated content 132 is output for display in a user interface.

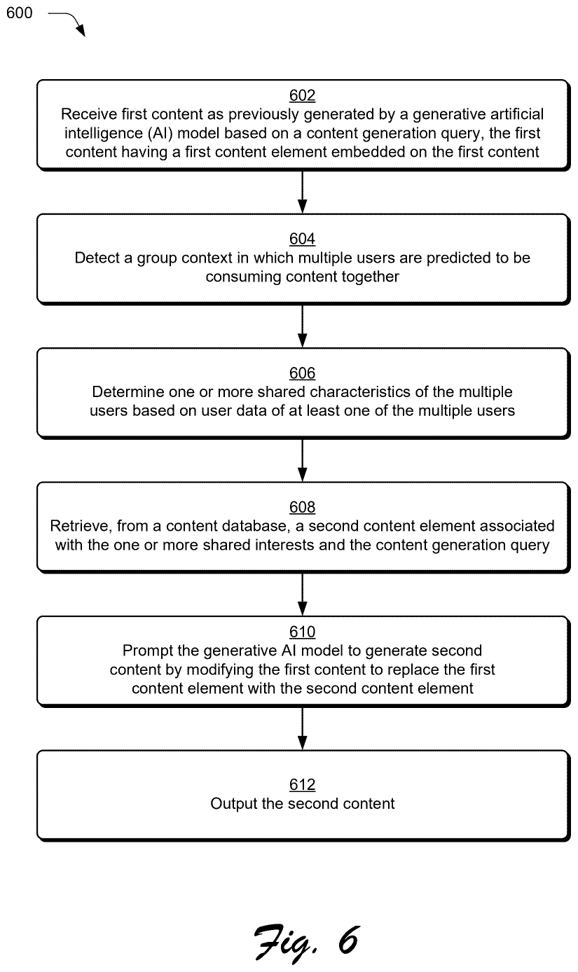

FIG. 6 illustrates a flow chart depicting an example method 600 of embedding content on generated content for a group audience in accordance with one or more implementations. At 602, first content is received as previously generated by a generative AI model based on a content generation query, and the first content has a first content element embedded on the first content. For example, the content embedding system 130 receives first content, e.g., the previously generated content 402. The first content was generated by the generative AI model 134 based on a content generation query 138. More specifically, the first content was generated in accordance with the described techniques by embedding a first content element on the previously generated content 402. However, the first content element was selected for embedding on the first content based on the interests, preferences, and/or demographics of a particular user, rather than the shared characteristics of a group of users.

At 604, a group context is detected in which multiple users are predicted to be consuming content together. For example, the group context module 204 detects, based on the group context data 202, a group context 136 in which multiple users 206 are predicted to be consuming content together, e.g., sharing the first content to a group message including the multiple users 206.

At 606, one or more shared characteristics of the multiple users are determined based on user data of the multiple users. For example, the shared characteristics module 208 determines one or more shared characteristics 210 of the multiple users 206 based on user data 122 of the multiple users. The one or more shared characteristics include shared interests, shared preferences, and/or shared demographic information of the multiple users 206 in various implementations.

At 608, a content element is retrieved from a content database, and the content element is associated with the one or more shared interests and the content generation query. For example, the query analysis module 212 analyzes the content generation query 138 (e.g., originally used to generate the first content) to identify the primary objects 214 of the query, and the candidate placements 216 (e.g., the primary object(s) 214 themselves and components of the primary object(s) 214) on the primary objects 214 where content elements 120 are embeddable. Further, the content selection module 218 retrieves content elements 120 that are relevant to the candidate placements 216. This is done by querying the content database 118 with the candidate placements 216, and retrieving the content elements 120 paired with the candidate placements 216 in the content database 118. From the relevant content elements 120, the content selection module 218 outputs a selected content element 220 based on the shared characteristics 210, e.g., the selected content element 220 is associated with an interest shared by all or a majority of the multiple users 206. In addition, the content selection module 218 outputs a selected placement 222 indicating where to embed the selected content element 220 based on a degree of relevance of the selected placement 222 to the selected content element 220.

At 610, the generative AI model is prompted to generate second content by modifying the first content to replace the first content element with the second content element. By way of example, the model prompting module 226 builds a prompt 228 that includes the first content, the selected content element 220, and the selected placement 222. Here, the prompt instructs the generative AI model 134 to create second content (e.g., the generated content 132) by replacing the first content element with the second content element (e.g., the selected content element 220). In addition, the prompt 228 instructs the generative AI model to embed the selected content element 220 on the selected placement 222 of the primary object 214, which may be a different placement than where the first content element was embedded. At 612, the generated content is output. For example, the generated content 132 is output for display in a user interface.

The example methods described above may be performed in various ways, such as for implementing different aspects of the systems and scenarios described herein. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the methods are described is not intended to be construed as a limitation, and any number or combination of the described method operations can be performed in any order to perform a method, or an alternate method.

FIG. 7 illustrates various components of an example device 700 in which aspects of embedding content on generated content for a group audience can be implemented. The example device 700 can be implemented as any of the devices described with reference to the previous FIGS. 1-6, such as any type of mobile device, mobile phone, mobile device, wearable device, tablet, computing, communication, entertainment, gaming, media playback, and/or other type of computer, consumer, and/or electronic device. For example, the device 102, the additional device 104, and/or the remote service provider system as shown and described with reference to FIGS. 1-6 may be implemented as the example device 700.

The device 700 includes communication transceivers 702 that enable wired and/or wireless communication of device data 704 with other devices. The device data 704 can include any of device identifying data, device location data, wireless connectivity data, and wireless protocol data. Additionally, the device data 704 can include any type of audio, video, and/or image data. Example communication transceivers 702 include wireless personal area network (WPAN) radios compliant with various IEEE 802.15 (Bluetooth™) standards, wireless local area network (WLAN) radios compliant with any of the various IEEE 802.10 (Wi-Fi™) standards, wireless wide area network (WWAN) radios for cellular phone communication, wireless metropolitan area network (WMAN) radios compliant with various IEEE 802.16 (WiMAX™) standards, and wired local area network (LAN) Ethernet transceivers for network data communication.

The device 700 may also include one or more data input ports 706 via which any type of data, media content, and/or inputs can be received, such as user-selectable inputs to the device, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to any type of components, peripherals, or accessories such as microphones and/or cameras.

The device 700 includes a processor system 708 of one or more processors (e.g., any of microprocessors, controllers, and the like) and/or a processor and memory system implemented as a system-on-chip (SoC) that processes computer-executable instructions. The processor system 708 may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits, which are generally identified at 710. The device 700 may further include any type of a system bus or other data and command transfer system that couples the various components within the device. A system bus can include any one or combination of different bus structures and architectures, as well as control and data lines.

The device 700 also includes computer-readable storage memory 712 (e.g., memory devices) that enable data storage, such as data storage devices that can be accessed by a computing device, and that provide persistent storage of data and executable instructions (e.g., software applications, programs, functions, and the like). Examples of the computer-readable storage memory 712 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 700 may also include a mass storage media device.

The computer-readable storage memory 712 provides data storage mechanisms to store the device data 704, other types of information and/or data, and various device applications 714 (e.g., software applications). For example, an operating system 716 can be maintained as software instructions with a memory device and executed by the processing system 708. The device applications 714 may also include a device manager, such as any form of a control application, software application, signal-processing and control module, code that is native to a particular device, a hardware abstraction layer for a particular device, and so on. Computer-readable storage memory 712 represents media and/or devices that enable persistent and/or non-transitory storage of information in contrast to mere signal transmission, carrier waves, or signals per se. Computer-readable storage memory 712 do not include signals per se or transitory signals.

In this example, the device 700 includes a content embedding system 718 that implements aspects of embedding content on generated content for a group audience and may be implemented with hardware components and/or in software as one of the device applications 714. For example, the content embedding system 718 can be implemented as the content embedding system 130 described in detail above. In implementations, the content embedding system 718 may include independent processing, memory, and logic components as a computing and/or electronic device integrated with the device 700.

In this example, the example device 700 also includes a camera 720 and sensors 722. The sensors, for instance, may include motion sensors such as may be implemented in an inertial measurement unit (IMU). The motion sensors can be implemented with various sensors, such as a gyroscope, an accelerometer, and/or other types of motion sensors to sense motion of the device. The various motion sensors may also be implemented as components of an inertial measurement unit in the device. Additionally or alternatively, the sensors include global positioning system (GPS) sensors for location tracking.

The device 700 also includes a wireless module 724, which is representative of functionality to perform various wireless communication tasks. The device 700 can also include one or more power sources 726, such as when the device is implemented as a mobile device. The power sources 726 may include a charging and/or power system, and can be implemented as a flexible strip battery, a rechargeable battery, a charged super-capacitor, and/or any other type of active or passive power source.

The device 700 also includes an audio and/or video processing system 728 that generates audio data for an audio system 730 and/or generates display data for a display system 732. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 734. In implementations, the audio system and/or the display system are integrated components of the example device. Alternatively, the audio system and/or the display system are external, peripheral components to the example device.

Although implementations of embedding content on generated content for a group audience have been described in language specific to features and/or methods, the subject of the appended claims is not necessarily limited to the specific features or methods described. Rather, the features and methods are disclosed as example implementations, and other equivalent features and methods are intended to be within the scope of the appended claims. Further, various different examples are described and it is to be appreciated that each described example can be implemented independently or in connection with one or more other described examples. Additional aspects of the techniques, features, and/or methods discussed herein relate to one or more of the following:

In some aspects, the techniques described herein relate to a system including: at least one memory; and at least one processor coupled with the at least one memory and configured to cause the system to: detect a group context in which multiple users are predicted to be consuming content together; determine one or more shared characteristics of the multiple users based on user data of the multiple users; receive a content generation query; retrieve, from a content database, a content element associated with the one or more shared characteristics and the content generation query; prompt a generative artificial intelligence (AI) model to generate content based on the content generation query, in part, by embedding the content element on the generated content; and output the generated content.

In some aspects, the techniques described herein relate to a system, wherein the at least one processor is configured to cause the system to detect the group context by detecting at least one of content sharing to a group presentation device, content sharing to a messaging group, and devices associated with the multiple users co-located at a physical location.

In some aspects, the techniques described herein relate to a system, wherein the at least one processor is configured to cause the system to determine the one or more shared characteristics based on the user data describing one or more of interests, preferences, or demographics of the multiple users.

In some aspects, the techniques described herein relate to a system, wherein the at least one processor is configured to cause the system to: receive previous content as previously generated by the generative AI model based on the content generation query, the previous content having a different content element embedded on the previous content; and prompt the generative AI model to modify the previous content by replacing the different content element with the content element, the modified content corresponding to the generated content.

In some aspects, the techniques described herein relate to a system, wherein the different content element and the content element are embedded at different locations within the previous content and the modified content, respectively.

In some aspects, the techniques described herein relate to a system, wherein the at least one processor is configured to cause the system to: identify a primary object of the content generation query; retrieve, from the content database, the content element associated with the one or more shared characteristics and the primary object; and prompt the generative AI model to generate the content, in part, by embedding the content element on the primary object of the generated content.

In some aspects, the techniques described herein relate to a system, wherein the at least one processor is configured to cause the system to: identify candidate placements on the primary object where content elements are embeddable; retrieve, from the content database, a plurality of content elements associated with the candidate placements; and select the content element from the plurality of content elements.

In some aspects, the techniques described herein relate to a system, wherein the candidate placements include the primary object as a whole and components of the primary object.

In some aspects, the techniques described herein relate to a system, wherein the content element is selected based on a degree of relevance of the content element with respect to the one or more shared characteristics, the content generation query, and a shared environmental context of the multiple users.

In some aspects, the techniques described herein relate to a system, wherein the content element corresponds to branded content of a brand, and the content element is selected based on at least one of promotions offered by the brand, alignment of the content generation query with a brand voice of the brand, endorsements of the brand, campaign objectives of the brand, and sponsorships of the brand.

In some aspects, the techniques described herein relate to a system, wherein the at least one processor is configured to cause the system to: select a particular placement of the candidate placements on which to embed the content element, the particular placement selected based on a degree of relevance of the content element with respect to the particular placement; and prompt the generative AI model to generate the content, in part, by embedding the content element on the particular placement of the primary object.

In some aspects, the techniques described herein relate to a system, wherein the at least one processor is configured to cause the system to iteratively prompt the generative AI model over one or more first iterations to generate the content, in part, by embedding the content element on the primary object of the generated content until the generated content satisfies a content quality threshold.

In some aspects, the techniques described herein relate to a system, wherein the at least one processor is configured to cause the system to iteratively prompt, responsive to a threshold number of the first iterations having failed to generate the content that satisfies the content quality threshold, the generative AI model over one or more second iterations to generate the content, in part, by embedding a different content element from the content database on the primary object of the generated content until the generated content satisfies the content quality threshold.

In some aspects, the techniques described herein relate to a system, wherein the at least one processor is configured to cause the system to prompt, responsive to the threshold number of the second iterations having failed to generate the content that satisfies the content quality threshold, the generative AI model to generate the content without a content element from the content database.

In some aspects, the techniques described herein relate to a device including: at least one memory; and at least one processor coupled with the at least one memory and configured to cause the device to: receive first content as previously generated by a generative artificial intelligence (AI) model based on a content generation query, the first content having a first content element embedded on the first content; detect a group context in which multiple users are predicted to be consuming content together; determine one or more shared characteristics of the multiple users based on user data of the multiple users; retrieve, from a content database, a second content element associated with the one or more shared characteristics and the content generation query; prompt the generative AI model to generate second content by modifying the first content to replace the first content element with the second content element; and output the second content.

In some aspects, the techniques described herein relate to a device, wherein the first content element is selected from the content database based on the user data describing a particular user that requested generation of the first content by the generative AI model, and the second content element is selected from the content database based on the one or more characteristics.

In some aspects, the techniques described herein relate to a device, wherein the at least one processor is configured to cause the device to: identify a primary object of the content generation query; retrieve, from the content database, the content element associated with the one or more shared characteristics and the primary object; and prompt the generative AI model to generate the second content, in part, by embedding the content element on the primary object of the generated content.

In some aspects, the techniques described herein relate to a device, wherein the at least one processor is configured to cause the device to: identify candidate placements on the primary object where content elements are embeddable; retrieve, from the content database, a plurality of content elements associated with the candidate placements; and select the second content element from the plurality of content elements.

In some aspects, the techniques described herein relate to a device, wherein the first content element and the second content element are embedded at different candidate placements on the primary object of the first content and the second content, respectively.

In some aspects, the techniques described herein relate to a method including: detecting a group context in which multiple users are predicted to be consuming content together; determining one or more shared characteristics of the multiple users based on user data of the multiple users; receiving a content generation query; retrieving, from a content database, a content element associated with the one or more shared characteristics and the content generation query; prompting a generative artificial intelligence (AI) model to generate content based on the content generation query, in part, by embedding the content element on the generated content; and outputting the generated content.

What is claimed is:

1. A system comprising:
at least one memory; and
at least one processor coupled with the at least one memory and configured to cause the system to:
detect a group context in which multiple users are predicted to be consuming content together;
determine one or more shared characteristics of the multiple users based on user data of the multiple users;
receive a content generation query;
retrieve, from a content database, a content element associated with the one or more shared characteristics and the content generation query;
prompt a generative artificial intelligence (AI) model to generate content based on the content generation query, in part, by embedding the content element on the generated content; and
output the generated content.

2. The system of claim 1, wherein the at least one processor is configured to cause the system to detect the group context by detecting at least one of content sharing to a group presentation device, content sharing to a messaging group, and devices associated with the multiple users co-located at a physical location.

3. The system of claim 1, wherein the at least one processor is configured to cause the system to determine the one or more shared characteristics based on the user data describing one or more of interests, preferences, or demographics of the multiple users.

4. The system of claim 1, wherein the at least one processor is configured to cause the system to:
receive previous content as previously generated by the generative AI model based on the content generation query, the previous content having a different content element embedded on the previous content; and
prompt the generative AI model to modify the previous content by replacing the different content element with the content element, the modified content corresponding to the generated content.

5. The system of claim 4, wherein the different content element and the content element are embedded at different locations within the previous content and the modified content, respectively.

6. The system of claim 1, wherein the at least one processor is configured to cause the system to:
identify a primary object of the content generation query;
retrieve, from the content database, the content element associated with the one or more shared characteristics and the primary object; and
prompt the generative AI model to generate the content, in part, by embedding the content element on the primary object of the generated content.

7. The system of claim 6, wherein the at least one processor is configured to cause the system to:
identify candidate placements on the primary object where content elements are embeddable;
retrieve, from the content database, a plurality of content elements associated with the candidate placements; and
select the content element from the plurality of content elements.

8. The system of claim 7, wherein the candidate placements include the primary object as a whole and components of the primary object.

9. The system of claim 7, wherein the content element is selected based on a degree of relevance of the content element with respect to the one or more shared characteristics, the content generation query, and a shared environmental context of the multiple users.

10. The system of claim 7, wherein the content element corresponds to branded content of a brand, and the content element is selected based on at least one of promotions offered by the brand, alignment of the content generation query with a brand voice of the brand, endorsements of the brand, campaign objectives of the brand, and sponsorships of the brand.

11. The system of claim 7, wherein the at least one processor is configured to cause the system to:
select a particular placement of the candidate placements on which to embed the content element, the particular placement selected based on a degree of relevance of the content element with respect to the particular placement; and
prompt the generative AI model to generate the content, in part, by embedding the content element on the particular placement of the primary object.

12. The system of claim 6, wherein the at least one processor is configured to cause the system to iteratively prompt the generative AI model over one or more first iterations to generate the content, in part, by embedding the content element on the primary object of the generated content until the generated content satisfies a content quality threshold.

13. The system of claim 12, wherein the at least one processor is configured to cause the system to iteratively prompt, responsive to a threshold number of the first iterations having failed to generate the content that satisfies the content quality threshold, the generative AI model over one or more second iterations to generate the content, in part, by embedding a different content element from the content database on the primary object of the generated content until the generated content satisfies the content quality threshold.

14. The system of claim 13, wherein the at least one processor is configured to cause the system to prompt, responsive to the threshold number of the second iterations having failed to generate the content that satisfies the content quality threshold, the generative AI model to generate the content without a content element from the content database.

15. A device comprising:
at least one memory; and
at least one processor coupled with the at least one memory and configured to cause the device to:
receive first content as previously generated by a generative artificial intelligence (AI) model based on a content generation query, the first content having a first content element embedded on the first content;
detect a group context in which multiple users are predicted to be consuming content together;
determine one or more shared characteristics of the multiple users based on user data of the multiple users;
retrieve, from a content database, a second content element associated with the one or more shared characteristics and the content generation query;
prompt the generative AI model to generate second content by modifying the first content to replace the first content element with the second content element; and
output the second content.

16. The device of claim 15, wherein the first content element is selected from the content database based on the user data describing a particular user that requested generation of the first content by the generative AI model, and the second content element is selected from the content database based on the one or more characteristics.

17. The device of claim 15, wherein the at least one processor is configured to cause the device to:
identify a primary object of the content generation query;
retrieve, from the content database, the content element associated with the one or more shared characteristics and the primary object; and
prompt the generative AI model to generate the second content, in part, by embedding the content element on the primary object of the generated content.

18. The device of claim 17, wherein the at least one processor is configured to cause the device to:
identify candidate placements on the primary object where content elements are embeddable;
retrieve, from the content database, a plurality of content elements associated with the candidate placements; and
select the second content element from the plurality of content elements.

19. The device of claim 18, wherein the first content element and the second content element are embedded at different candidate placements on the primary object of the first content and the second content, respectively.

20. A method comprising:
detecting a group context in which multiple users are predicted to be consuming content together;
determining one or more shared characteristics of the multiple users based on user data of the multiple users;
receiving a content generation query;
retrieving, from a content database, a content element associated with the one or more shared characteristics and the content generation query;
prompting a generative artificial intelligence (AI) model to generate content based on the content generation query, in part, by embedding the content element on the generated content; and
outputting the generated content.
